(19) United States
(12) Patent Application Publication
(10) Pub. No.: US 2005/0224103 A1
(43) Pub. Date: Oct. 13, 2005

(54) Centrifugal container cleaning system

(76) Inventors: Kert L. Dolechek, Kalispell, MT (US); Ronald G. Breese, Whitefish, MT (US); Gordon R. Nelson, Kalispell, MT (US)

Correspondence Address: PERKINS COIE LLP/SEMITOOL, PO BOX 1208, SEATTLE, WA, 98111-1208, US

(21) Appl. No.: 11/097,950

(22) Filed: Apr. 2, 2005

Related U.S. Application Data
(63) Continuation-in-part of application No. PCT/US03/32131, filed on Oct. 10, 2003.
(60) Provisional application No. 60/559,281, filed on Apr. 2, 2004.

(51) Int. Cl. B08B 3/02

(52) U.S. Cl. 134/148; 134/166 R; 134/169 R; 134/153

(57) ABSTRACT

A system for centrifugally cleaning containers used for holding wafers can easily be loaded and unloaded. A rotor in the system has a first plate above a second plate, and box holding positions between the plates. Spray nozzles are positioned to spray a cleaning liquid towards the rotor. A gate is moveable vertically between an up position, for loading and unloading a box into the box holding position, and a down position, for securing a box in place during centrifugal cleaning. Door holding positions are also provided between the plates, for holding container doors.

### PRIORITY CLAIM

This Application claims priority to U.S. Provisional Patent Application Ser. No. 60/559,281, filed Apr. 2, 2004, and incorporated herein by reference. This application is a Continuation-in-Part of International Patent Application PCT/US2003/032131, filed Oct. 10, 2003 and claiming priority to U.S. patent application Ser. No. 10/286,317, filed Nov. 1, 2002, now U.S. Pat. No. 6,830,057, both incorporated herein by reference.

### FIELD OF THE INVENTION

The field of the invention is systems for cleaning containers used to hold and process semiconductor wafers, substrates, flat panel displays and similar flat articles or workpieces requiring low contamination levels.

The processing of semiconductor wafers, substrates, photomasks, flat panel displays, data disks, optical media and other articles relating to the semiconductor industry (collectively referred to here as “wafers”) is very sensitive to contamination. Wafers require extremely low contamination levels. Even microscopic particles can cause defects. Accordingly, it is necessary to maintain a high level of cleanliness during virtually all manufacturing steps.

Wafers and similar articles are often moved, stored or processed in batches. Batch handling may occur throughout the entire production process, or for one or more processing steps or related handling operations. Batch processing generally involves using a carrier, container, or box (collectively referred to here as a carrier) to hold the wafers. The carriers can be of various designs. In box types of carriers, the wafers are enclosed or sealed against contamination. Other carriers, such as cassettes, are open, to allow process liquids or gases to contact the wafers held by the carrier. The carriers must be cleaned after use, to avoid having particles and contaminants on the carriers contaminate the next batch of wafers placed into the carrier.

One type of carrier is the front opening unified pod, or FOUP. A FOUP carrier is a five-sided box with an open front. A door attaches to the front of the box, to seal the box against entry of external contaminants, to help keep the wafers clean. A front opening shipping box or FOSB is a similar type of container. These types of containers are generally designed to hold 200 mm or 300 mm wafers. Consequently, their relatively large sizes, and certain other features such as grooves, slots, openings, etc. can make cleaning them difficult. The FOUP doors, which are removable from the box, must also be cleaned.

Carriers have been successfully cleaned in centrifugal cleaners. In the centrifugal cleaners shown for example in U.S. Pat. Nos. 5,738,128; 6,432,214; 6,322,633; 6,412,502; 6,830,057; 6,691,718; and in Published U.S. Patent Application No. 20020100495, all incorporated herein by reference, the box or carrier is loaded onto a rotor, with the open top or front side of the box facing radially outwardly from the rotor. The box is then sprayed with cleaning fluids, and then with drying gases, while the rotor turns. Centrifugal force helps to remove cleaning fluids from the box during drying. While these techniques have worked well for different types of carriers and boxes, achieving better and more reliable cleaning, and loading and unloading, of boxes and doors, remains as an engineering design challenge. As FOUP and similar carriers or containers include a box and a separate door, which must both be cleaned, an apparatus for efficiently cleaning both components is also needed.

### SUMMARY OF THE INVENTION

In contrast to earlier designs, the present container cleaner has a rotor formed by plates (or rings). The containers are supported on the plates. The plates substantially define the outer perimeter of the rotor. Contrary to conventional design objectives, the plates have more surface area than the frame or ladder structures of earlier designs. However, it has been discovered that the plates surprisingly dry more quickly, due to their simple geometry. In addition, potential for trapping or holding liquid in recesses, corners, etc. is reduced, via the simpler geometry of the plates.

In a first aspect, a rotor in the system has a first plate above a second plate, and a plurality of box holding positions in the rotor between the first plate and the second plate. Spray nozzles are positioned to spray a cleaning liquid towards the rotor. Locating the box holding positions between the plates provides an efficient and compact design. Drying times are also reduced because the rotor has improved air flow through characteristics, and the rotor itself has fewer components and surfaces to be dried.

In a second aspect, the boxes are optionally located and/or secured into the box holding positions using pins extending up from the second plate. The pins, if used, allow the boxes to be reliably and accurately located into the box holding positions, either manually, or via a robotic loader.

In a third aspect, a gate at the box holding position is moveable vertically between an up position, for loading and unloading a box into the box holding position, and a down position, for securing a box in place during centrifugal cleaning. The gate allows for quick loading and unloading, while also firmly holding the box in the box holding position against centrifugal forces during centrifugal cleaning.

In a fourth aspect, the rotor also includes box door holding positions, between the first and second plates. Box doors are advantageously held in the door holding positions by top inner and outer door holders attached to the first plate, and by bottom inner and outer door holders attached to the second plate.

Other and further objects, inventive features, and advantages, will appear hereinafter. The invention resides as well in subsystems and subcombinations of the features described. It is an object of the invention to provide improved cleaning apparatus and methods.

### BRIEF DESCRIPTION OF THE DRAWINGS

In the drawings, wherein the same reference number denotes the same element, throughout the several views:

FIG. 1 is a perspective view of a system for cleaning carrier boxes and carrier doors, used in handling semiconductor wafers and similar articles.

FIG. 2 is a front view of the system shown in FIG. 1.

FIG. 3 is a schematic perspective view of system components within the enclosure shown in FIGS. 1 and 2.

FIG. 4 is a perspective view of the rotor shown in FIGS. 1-3.

FIG. 5 is an enlarged perspective view of a section of the rotor shown in FIG. 4.

FIG. 6 is an enlarged exploded perspective view of additional components of the rotor shown in FIGS. 4 and 5.

FIG. 7 is a side view of the rotor shown in FIG. 4.

FIG. 8 is a section view taken along line 8-8 of FIG. 7.

FIG. 9 is a perspective view of an alternative upper door holder.

FIG. 10 is a perspective view of an alternative lower door holder.

### DETAILED DESCRIPTION OF THE DRAWINGS

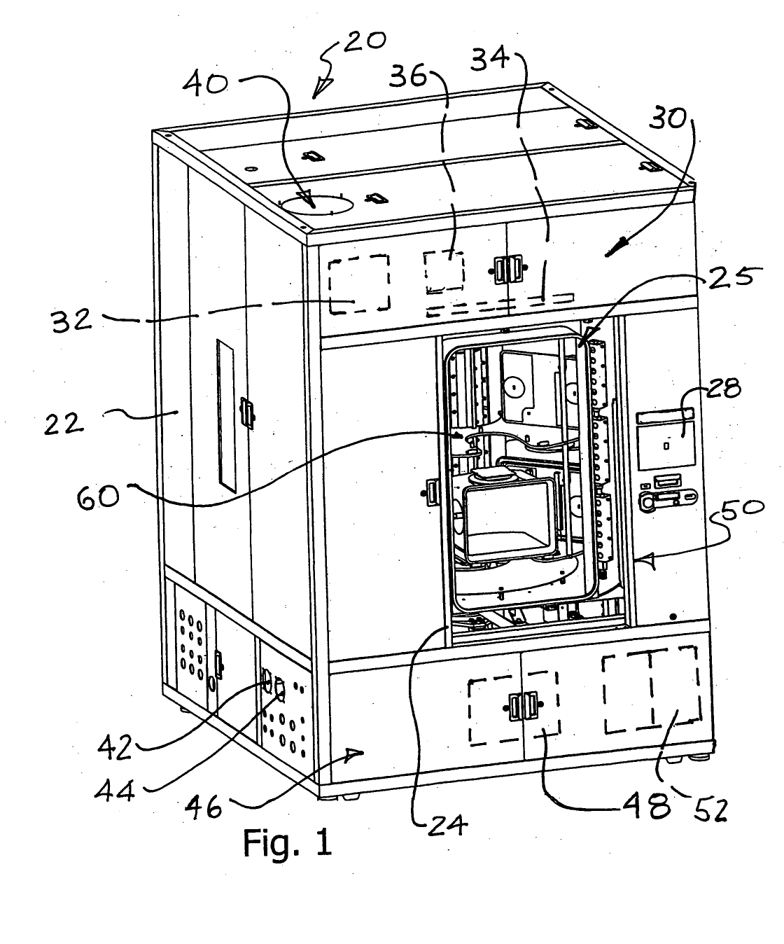

Turning now in detail to the drawings, as shown in FIGS. 1, 2 and 3, a cleaning system 20 has a rotor 60 within a chamber 56 within an enclosure 22. A first or front door 24 opens and closes off an opening or doorway 25 through the enclosure and chamber 56. Typically, air heaters 32, air filters 34, and a deionizer 36 are included in an upper section 30 of the enclosure 22. A factory or fab air inlet 40 in the upper section 30 can be used to supply air into the upper section.

A lower section 46 of the enclosure 22 generally includes connections 42 and 44, for supplying and/or removing or draining water, air, or gasses used in cleaning containers. A center or middle section 50 of the cleaning system 20 has a rotor 60 rotatably mounted within a chamber or bowl 56 within the enclosure 22. The rotor 60 is linked to a spin motor 48 in the lower section 46, for rotating the rotor 60. Of course, the description above reflects typical design elements which are not essential to the invention.

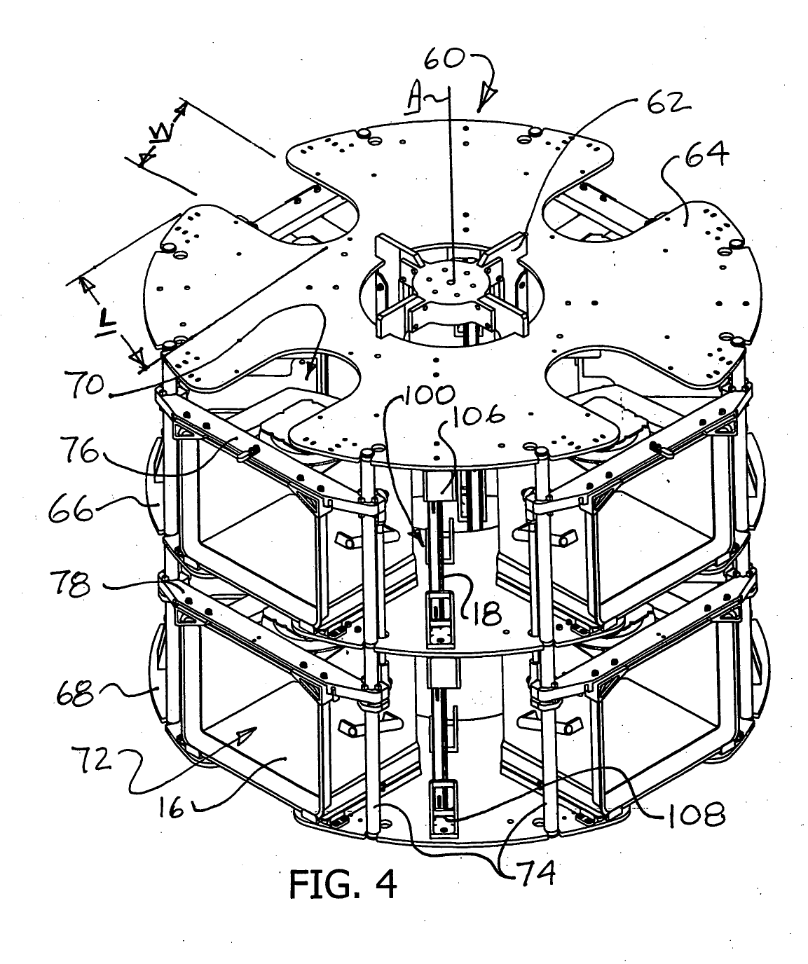

Referring now to FIGS. 4, 5 and 6, in the specific embodiment shown, the rotor 60 has a first or top plate 64, a second or center plate 66, and a bottom or third plate 68 attached to an interior frame 62. Cut-outs or slots 70 can be provided in each of the plates 64, 66 and 68, at each box holding position 72 in the rotor 60. The cut outs 70, if used, allow for clearance during loading and unloading via a robotic loader. As shown in FIG. 4, the cut outs 70, if used, in most cases, have a width W greater than 5,10,15, or 20% of the diameter D of the rotor, and in most cases will typically be about 10%. The cutouts 70 have a length L that is about the same or greater than the width W.

While the design shown in FIGS. 4-6 has an upper level 85 of box holding positions 72 (between the top plate 64 and the center plate 66), and a second or lower level 95 of box holding positions 72 (between the center plate 66 and the bottom plate 68) the rotor 60 may also be made with only a single level of box holding positions. Alternatively, the rotor 60 may be made with multiple levels, e.g., two, three, four or five levels, using the same design features and concepts as in the two level design, shown as an example in FIGS. 1-7.

In the design shown in the drawings, there are four box and door holding positions on each level, and there are two levels, so that the rotor 60 can hold up to a total of eight boxes and doors. However, other equivalent arrangements may also be used, with, for example, two, three, four or five box holding positions 72 on each level. Designs with the box holding positions 72 equally spaced apart, and/or symmetrically positioned on the rotor 60, are generally preferred, in order to have the rotor 60 remain rotationally balanced, to reduce or avoid vibration as the rotor 60 spins.

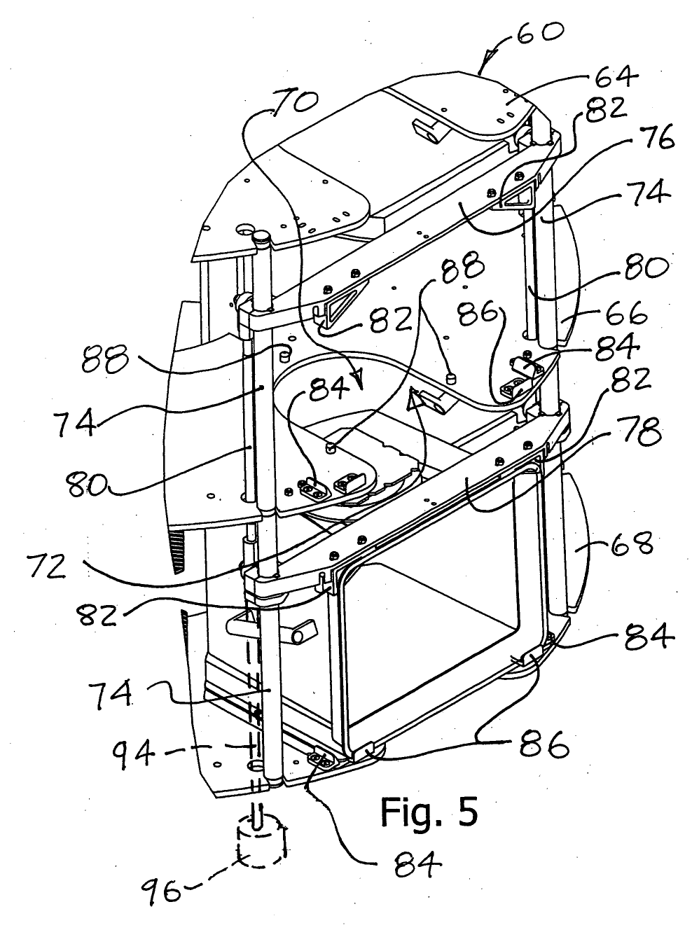

Referring still to FIGS. 4, 5 and 6, gateposts 74 extend between and are attached to the plates 64, 66 and 68, adjacent to the outer perimeter of the plates. Upper and lower retainer gates 76 and 78 are supported and can shift vertically on the gateposts 74, as described in U.S. Pat. No. 6,830,057, incorporated herein by reference. The gates 76 and 78 can be connected by links or bars 80, so that they both can move up and down together. In designs where the gates are moved by hand, the gates are generally separate and not connected to each other. As shown in dotted lines in FIG. 5, link extensions 94 may extend from the links 80 down to gate actuator 96, for automatic or computer controlled movement of the gates.

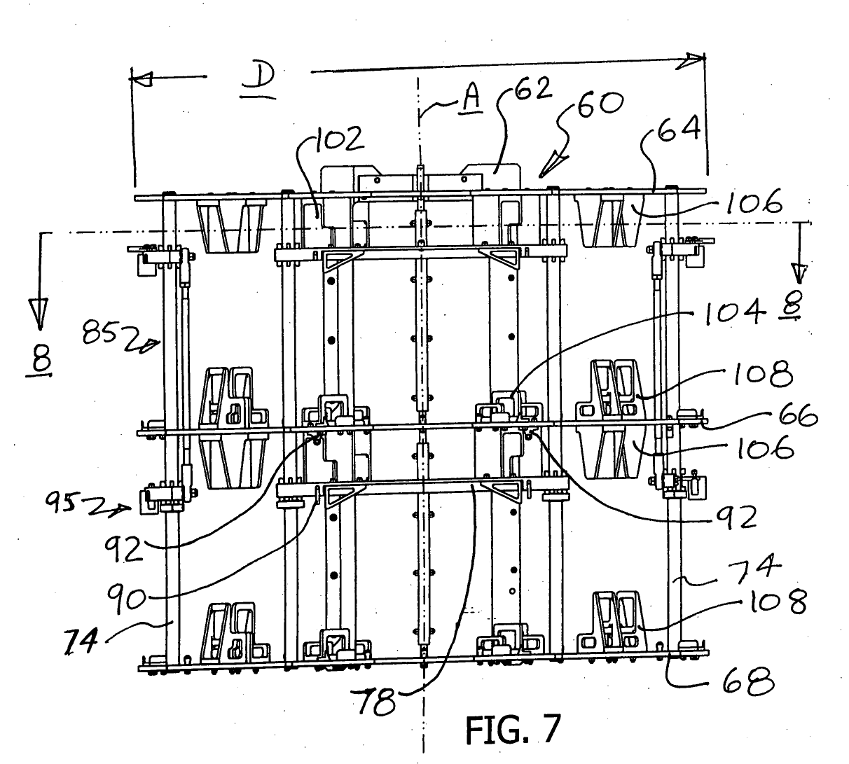

As shown in FIG. 5, left and right holders 82 extend down from the gate 76 and 78. The holders 82 are advantageously plastic, and are shaped to fit over the top front corners of the boxes 16. Side blocks or tabs 84 are attached to the plate 66, on opposite sides of the cut-out 70. Front blocks or tabs 86 are similarly attached to the plates 66 and 68. The blocks 84 and 86 each have a raised wall or lip, which helps to guide, position, or hold a box 16. Three alignment pins 88, if used, are provided at each box holding position 72 on each of the plates 66 and 68. The pins are located to engage into openings on the bottom of the box 16. Referring momentarily to FIG. 7, a gate latch pin 90 on the gate 78 is engageable into a latch opening 92, on the bottom surface of the plate 66, for holding the gates 76 and 78 in an up position, during loading and unloading. If the gates 76 and 78 are set up for manual and separate operation, a gate latch pin 90 may be provided on each gate.

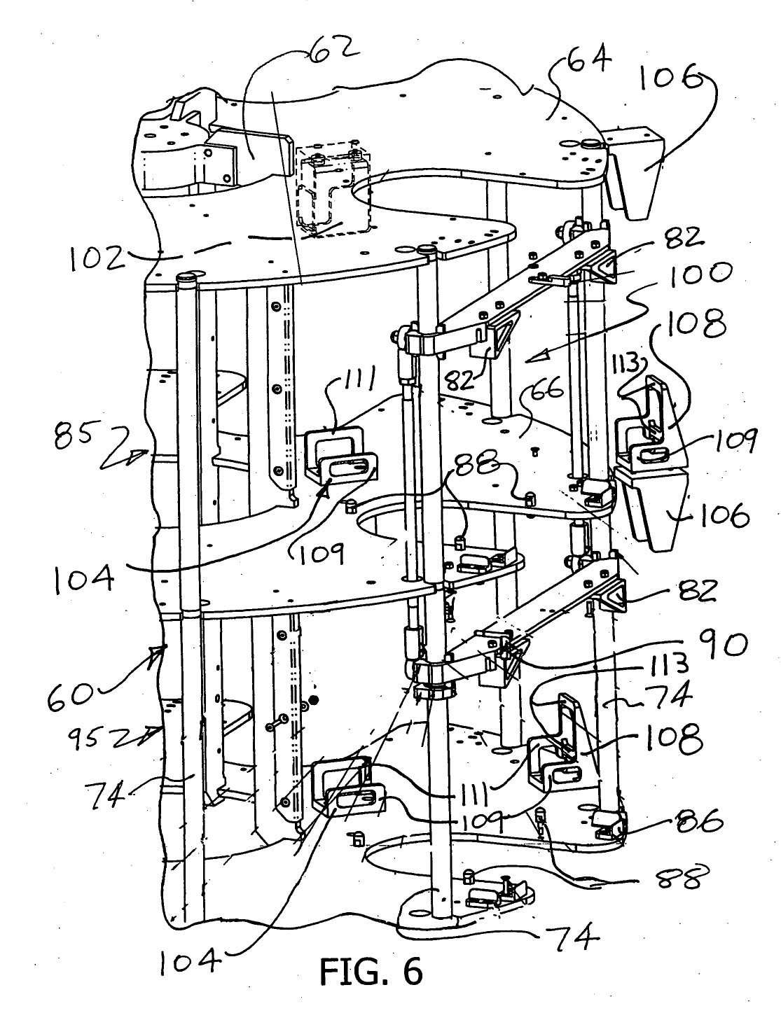

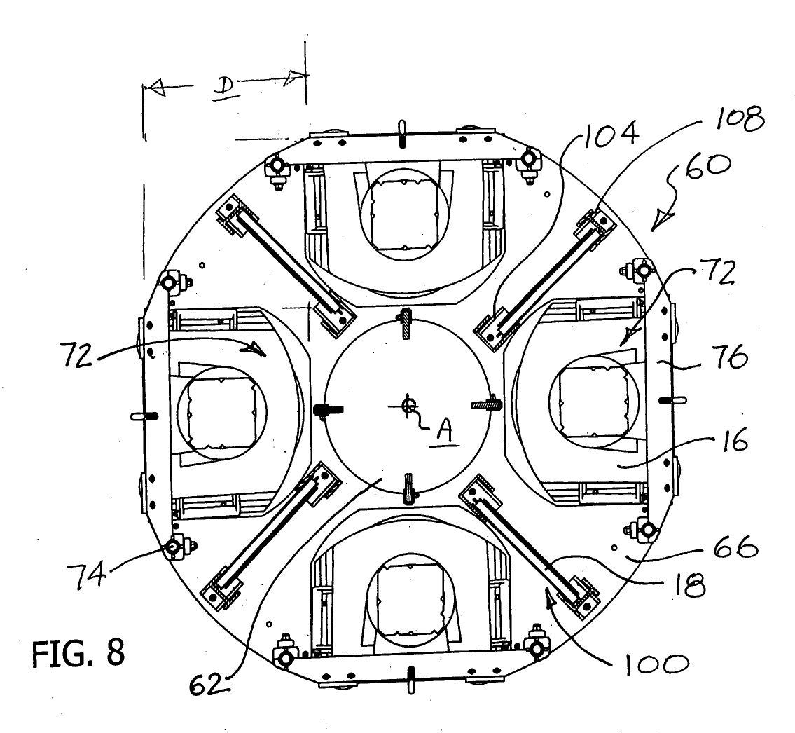

Turning now to FIGS. 6, 7 and 8, the doors 18 of the containers (such as FOUPS or FOSB) may be advantageously cleaned along with the boxes 16, in door holding positions 100 in the rotor 60. As shown in FIGS. 4 and 8, a door holding position 100 is advantageously provided in-between each of the box holding positions 72. However, as with the box holding positions 72, the door holding positions 100 may be arranged in other ways or with different spacings. Specifically, the positions, spacing, and orientation of the boxes and doors can be varied for different applications.

As shown in FIG. 8, the box holding positions 72 and door holding positions 100 are arranged so that the open front end of the box 16 faces outwardly (parallel, and optionally co-linear) with a center line passing through the axis of rotation A of the rotor 60. The door holding positions 100 are advantageously arranged to hold the doors 18 so that they lie in a plane extending radially outwardly from the rotation axis A (although as shown in FIG. 8, they may be centered on a line offset from the axis A, and may also be off set from each other).

Also as shown in FIG. 8, the plates 64, 66, and 68 may be generally round, with flats at the box holding positions. The plates 66 and 68 extend radially out from the frame 62, with the blocks 86 at the edge or perimeter of the plates. As shown in FIG. 5, with a box secured in a box holding position, the front edge of the box is adjacent to or generally close to alignment with the edge or perimeter of the plate.

As shown in FIGS. 6 and 7, at each door holder position 100 a top rear or inner cup or holder 102, a bottom inner or rear cup or holder 104, a top front or outer cup or holder 106, and a bottom front or outer cup or holder 108, are provided. Referring to the door holder position 100 shown in FIG. 6, the top holders 102 and 106 are attached to the bottom surface of the plate 64. The bottom holders 104 and 108 are attached to the top surface of the plate 66. (The exploded perspective view of FIG. 6 shows the holders 106, and the upper level holder 108, spaced apart from the plates 64 and 66, only for purpose of illustration.) As shown in FIGS. 6 and 7, the bottom holders 104 and 108 each have a first shorter leg 109 spaced apart from a second taller leg 111 and forming a slot between them. In contrast, the front holders 106 and 109 both have front surfaces 113 to hold the door in place during centrifugal cleaning.

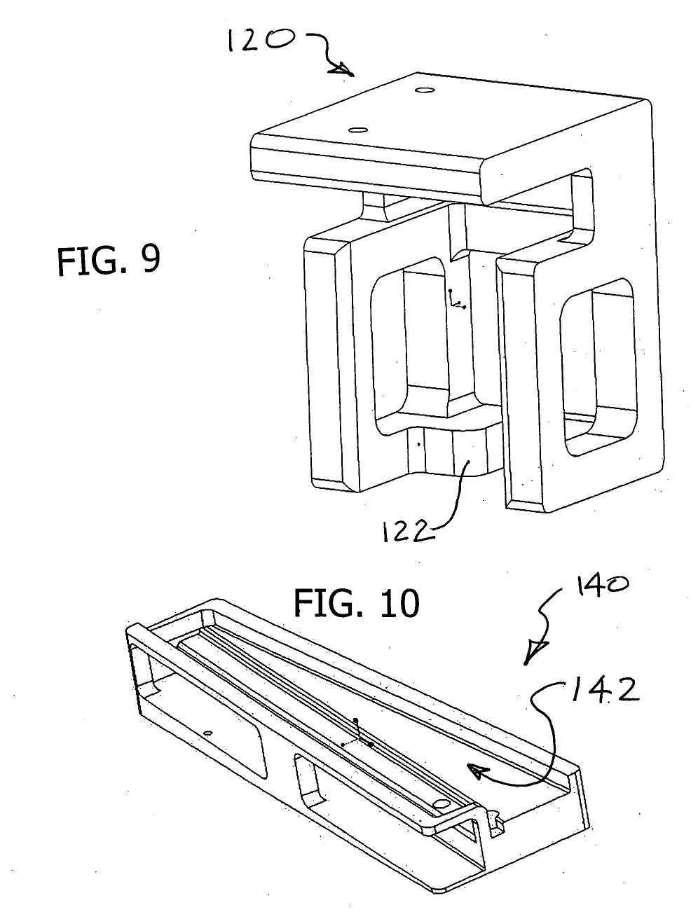

FIGS. 9 and 10 show alternative upper and lower door holders 120 and 140. The upper door holder 120 is similar to the holder 102, and includes a step or guide 122 which helps to guide the top rear corner of a door 18 in the holder 120. FIG. 10 shows a lower door holder 140 which can be used in place of both of the lower or bottom holders 104 and 108. In contrast to the bottom holders 104 and 108, the holder 140 allows the door 18 to be loaded via a straight (radially) in movement, in the groove or slot 142. Shifting the front edge of the door 18 sideways then secures the door in place.

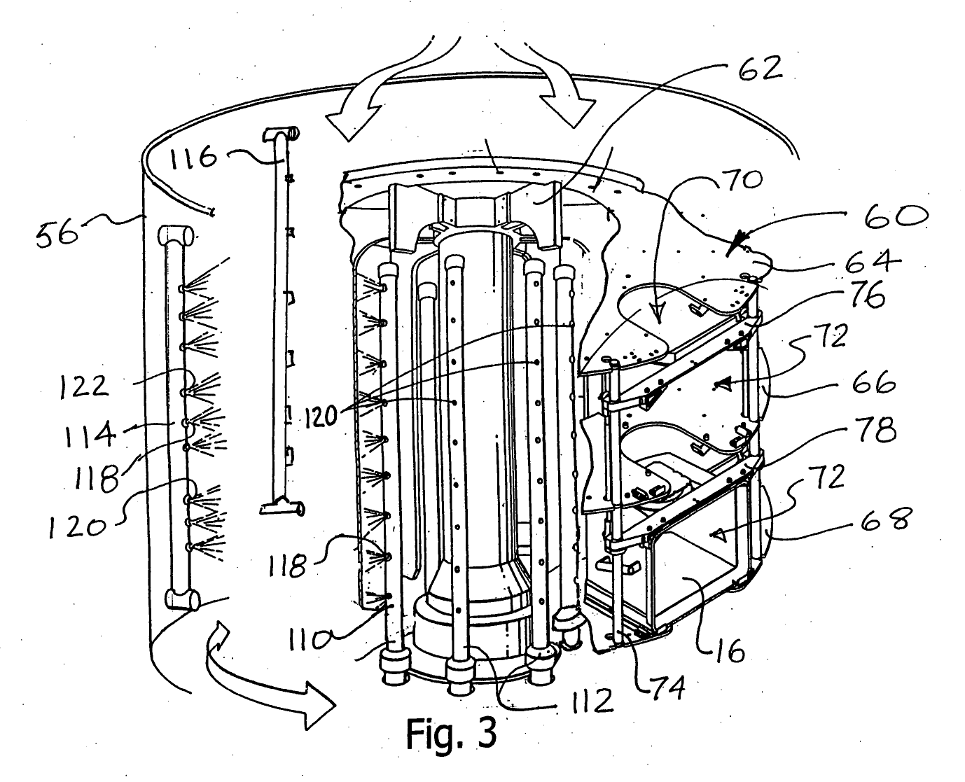

Turning to FIG. 3, inner liquid and gas or air manifolds 110 and 112, if included, are fixed in position and extend up from the floor or bottom of the chamber 56. The manifolds 110 and 112 extend up through large central openings in the plates 64, 66 and 68, so that the rotor 60 rotates around the manifolds. Outer liquid and gas or air manifolds 114 and 116 are positioned on or in the cylindrical walls of the chamber 56, around the outside of the rotor 60. The manifolds 110, 112, 114 and 116 have spray nozzles which spray liquids or gasses onto the boxes and doors, to clean and dry them. The nozzles may be straight spray nozzles 118, left/right angle spray nozzles 120, and/or up/down spray nozzles 122, and combinations of them, as described in U.S. Pat. No. 6,797,076 or International Patent Application WO02/17355, incorporated herein by reference. The outer nozzles are advantageously a combination of angle spray (e.g. 30-60, 40-50 or about 45 degree) nozzles and cone spray nozzles, for cleaning and rinsing the inside surfaces of the boxes. The inner nozzles are advantageously fan spray nozzles, for cleaning and rinsing the outside surfaces of the boxes and doors.

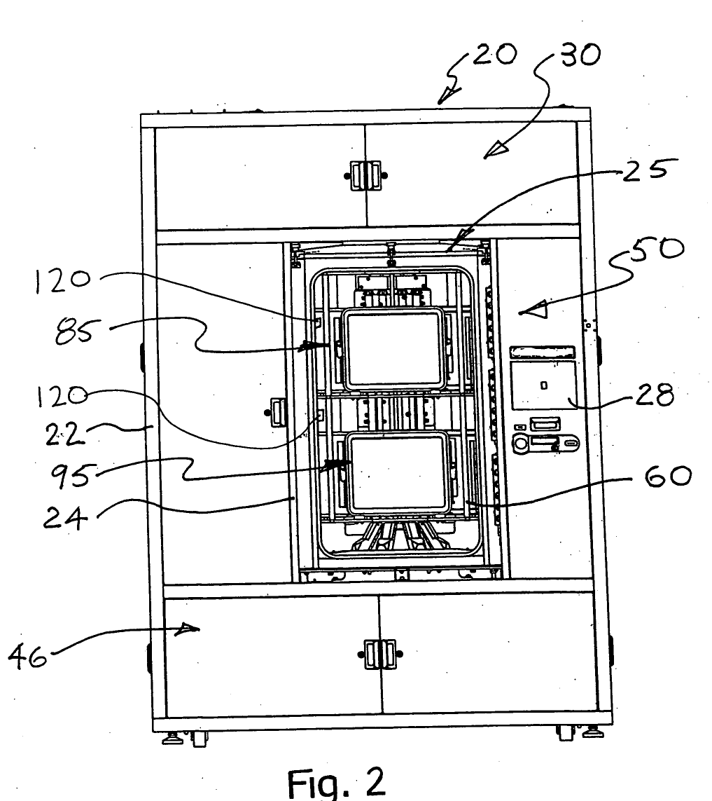

In use, the door 24 is opened, either manually or by using the control panel 28, on the front of the enclosure 22. The rotor 60 is positioned as shown in FIGS. 1 and 2, with a box holding position 72 generally centrally aligned within the door opening, and with a door holding position 100 also in the opening. The door opening 25 through the enclosure 22 and chamber 56, is advantageously made wide enough so that both a box holding position 72 and a door holding position 100 are accessible through the enclosure opening 25 without moving the rotor 60. Alternatively, the door opening 25 can be narrower, and the rotor 60 can be rotated by about 45 degrees between loading a box and loading a door.

In either case, a box door 18 is typically removed from its box 16 and is moved into a door holding position 100 by moving the door into the rotor 60, with the top edge of the door moved in-between the legs of the top rear holder 102. The door 16 is then pulled out slightly, so that the front upper corner of the door fits within the top front holder 106. The bottom edge of the door is then swung or moved laterally, with the bottom edge of the door passing over the short legs 109 of the bottom supports 104 and 108. The door is then moved down slightly, so that the bottom edge of the door rests between the legs 109 and 111 of the bottom holders 104 and 108. In this position, the door 18 is secured in place with the door holder position 100. These steps are repeated for door holding positions 100 aligned in the door opening 25 at each level 85, 95 (and for additional rotor levels, if used). While described here as a manual or hand loading method, these steps may also be performed by a robot in an automated or robotic loading system.

The gates 76 and 78 are moved into the up position, and are held in place by moving the gate latch pin 90 into the receptacle or receiver 92. A box 16 is then moved into the box holding position 72. The side blocks 84 help to align and guide the box 16 as it is moved into the rotor 60. The box 16 is moved radially inwardly, and then downwardly slightly, with holes in the bottom surface of the box 16 moving down over the pins 88 (if the optional pins 88 are included). The vertical tabs on the front blocks 86 extend up over the front lower edge of the box 16. The gate latch pin 90 is removed and the gates 76 and 78 are lowered. The holders 82 on the gates 76 and 78 engage over the top front corners of the box 16. The box 16 is then secured in place. These steps are repeated for box holding positions 72 aligned in the door opening 25 at each level 85, 95 (and for additional rotor levels, if used). Alternatively, the door/box loading sequence may be alternated, by loading a door, and then a box, and then the next door, etc. As with the doors, these loading steps for the boxes may also be achieved via a robot. The optional cutouts 70 allow clearance for a robotic loader to move a box into and out of the box holding positions.

The rotor 60 is then indexed to bring the next box holding position 72 or door holding position 100 into alignment with the door opening 25. The loading procedure described above for the door and the box is then repeated, for each level of the rotor 60. During the loading procedure, the rotor 60 may be rotated or indexed either manually or via the control panel 28. When the rotor 60 is fully loaded with boxes and doors, the chamber and enclosure door 24 is closed.

In the design shown in the drawings, the plates 66 and 68 and gates 76 and 78 are metal, e.g., stainless steel. The holders 82, side blocks 84, front blocks 86, and the door holders 104, 106, and 108, are advantageously a non-metal material, such as PVDF. As a result, most or substantially all of the surfaces making actual contact with the box 16 and door 18 are non-metal. This may reduce any potential for metal contamination of the boxes and doors, in certain applications. Sensors, such as optical sensors 120, shown in FIG. 2, sense whether the gates are in a full down position. The rotor makes one complete slow 360° turn to bring the gates into alignment with the sensors. After the sensors have detected that all of the gates are down, the cleaning process may begin.

The particular steps used in the cleaning process may vary in terms of the liquids and gasses used, temperatures, flow rates, rotation speeds and directions, spray angles, etc. Process parameters may be programmed in advance via the control panel 28 or via other factor or fab computers connected to the system 20. Generally, the motor 48 spins the rotor 60, in a first direction, while a cleaning liquid, typically deionized water, is sprayed onto the boxes and doors. Additives, such as surfactant, detergent, or chelating agents may be added into the water or other liquid, by aspiration, pumping, or other techniques. The system can of course also operate with the rotor only partially loaded with boxes and/or doors. In this case, the boxes and doors are preferably loaded symmetrically to better maintain the rotor in rotational balance.

The combinations of up/down, left/right, and straight spray nozzles effectively distribute the liquid spray onto the boxes and doors. After a predetermined time, for most uses, the direction of rotation of the rotor is reversed, while spraying of cleaning liquid continues. Drying then begins, typically by rotating the rotor 60 at a higher rotation speed. This tends to centrifugally remove liquid from the boxes. Heated air may also be passed down over and through the rotor, from the fab air inlet 40, or other internal or external source. Drying gasses or air may also be sprayed out from the gas manifolds 112 and 116, to aid in drying, as described, for example, in U.S. Pat. Nos. 5,224,503; 6,432,214; 6,797,076; and U.S. patent application Ser. No. 10/043,716, incorporated herein by reference. When drying is complete, the system 20 is unloaded using the reverse sequence of steps described above. Although manual operations are possible, operation of the system 20 during cleaning and drying, as well as incremental rotation of the rotor 60 during loading and unloading, and operation of the door 24, is preferably controlled by an electronic controller or computer within the system 20 and linked to the control panel 28, or optionally by a remote factory or fab computer linked to the system 20.

During cleaning and drying, the box doors 18 are secured in place against centrifugal force, by the front surfaces 113 of the holders 106 and/or 108. The boxes 16 are held in place against centrifugal force by the corner holders 82 on the gates 76 and 78. The boxes 16 may also be held in place by the pins 88, if used, and the front blocks 86. Non-metal spacers may be used instead of the pins. As shown in FIG. 7, as the rotor 60 has a relatively open frame structure, the spraying of liquids and gasses onto the boxes and doors, and the flow of drying air across the boxes and doors, is largely unobstructed. In addition, the cut-outs 70 also allow for air movement through the rotor.

Instead of using the manifolds, the nozzles may also be separately supplied with gas or liquids, for example via separate plumbing lines.

The diameter of the plates 64, 66 or 68 substantially define the diameter of the rotor 60. However, as shown in FIG. 8, gates 76 or 78 may project slightly out beyond the circumference of the plates. The diameter (or characteristic dimension extending across through the axis D) of the plate is 2-6, or 3-4 or 5 times greater than the diameter of the interior frame. For the particular design shown in the drawings, which is adapted to clean boxes which hold 300 mm diameter wafers or workpieces, the diameter of the plates 64, 66 or 68 is about 2-6, 3-5, or 4 times greater than the depth D of the boxes.

Thus, a novel container cleaning system has been shown and described. Various changes and substitutions may of course be made without departing from the spirit and scope of the invention. The invention, therefore, should not be limited, except to the following claims, and their equivalents.

1. A system for cleaning containers used for holding flat workpieces, comprising:
a rotor having a first plate and a second plate;
a plurality of box holding positions in the rotor between the first plate and the second plate; and
a plurality of spray nozzles positioned to spray a cleaning liquid towards the rotor.

2. The system of claim 1 wherein the first plate is a top plate and the second plate is a bottom plate and with the top plate parallel to and vertically spaced apart from the bottom plate, and with the plurality of box holding positions located substantially entirely between the top and bottom plates.

3. The system of claim 1 wherein the plates are substantially round and flat, and with the plates having a radius greater than a length, width or depth of the container.

4. The system of claim 1 further comprising a gate at one or more of each box holding position, with the gate moveable vertically between an up position, for loading and unloading a box into the box holding position, and a down position, for securing a box in place during centrifugal cleaning.

5. The system of claim 4 further comprising a pair of spaced apart gate posts extending between the first and second plates, at the perimeter of the plates, at each box holding position, and with the gate moveable vertically along the gate posts.

6. The system of claim 4 further comprising a pair of corner holders on each gate, with the corner holders adapted to engage onto an corner of a box.

7. The system of claim 1 further including a pair of front blocks attached to the second plate at each box holding position.

8. The system of claim 1 further comprising a plurality of box door holding positions in the rotor, between the first and second plates, with at least one of the box door holding positions having top inner and outer door holders attached to the first plate, and having a bottom door holder attached to the second plate.

9. The system of claim 1 with first and second plates each having concentric central openings, and with the rotor further including an internal frame attached to the first plate and the second plate, and extending through the central openings.

10. The system of claim 1 further including a cutout in the first plate and in the second plate at one of more of the box holding positions.

11. A container cleaning machine, comprising:
an enclosure;
a rotor in the enclosure, with the rotor including:
a first plate;
a second plate above the first plate;
one or more front blocks attached to the first plate, at an outer perimeter of the first plate, to provide a container holding position between the first and second plates;
one or more lower door holders on the first plate, forming a door holding position; and
one or more upper door holders on the second plate, at the door holding position.

12. The container cleaning machine of claim 11 further comprising a pair of gate posts extending vertically from the first plate to the second plate, at the container holding position, and a retainer gate moveable up and down on the gate posts.

13. The container cleaning machine of claim 11 further comprising first and second side blocks on the first plate, with the front blocks located between the first and second side blocks.

14. The system of claim 11 further comprising a pair of corner holders on each gate, with the corner holders adapted to engage onto an corner of a box.

15. The system of claim 12 wherein the second plate extends out at lest partially over the retainer gate.

16. The system of claim 11 wherein the second plate is concentrically aligned over the first plate, at a fixed distance above the first plate.

17. The system of claim 12 further comprising an actuator for lifting and lowering the retainer gate.

18. A container cleaning machine, comprising:
a cleaning chamber;
a rotor within the cleaning chamber;
a plurality of spray nozzles in the cleaning chamber directed at the rotor;
with the rotor including:
a bottom plate;
a middle plate above the bottom plate;
a top plate above the middle plate;
with the bottom, middle and top plates generally aligned and concentric with each other;
a plurality of lower level box holding positions between the bottom and middle plates and a plurality of upper level box holding positions between the middle plate and the top plate;
with substantially each lower level box holding position including a vertically moveable retainer gate, and one or more box front retaining elements on the bottom plate;
and with substantially each upper level box holding position including a vertically moveable retainer gate, and one or more box front retaining elements on the middle plate.

19. The machine of claim 18 with the retainer gate at the lower box holding position linked to the retainer gate at the upper box holding position, and further including an actuator for lifting and lowering the retainer gates.

20. The machine of claim 18 further including:
a plurality of lower level door holding positions between the bottom and middle plates and a plurality of upper level door holding positions between the middle plate and the top plate;
with substantially each lower level door holding position including one or more lower door holding elements on the bottom plate, and one or more upper door holding elements on the middle plate;
and with substantially each upper level door holding position including and one or more lower door holding elements on the middle plate, and one or more upper door holding elements on the top plate.
